(19) United States
(12) Patent Application Publication
(10) Pub. No.: US 2004/0008518 A1
(43) Pub. Date: Jan. 15, 2004

(54) Easily assembled lamp assembling device

(76) Inventors: Wen-Chang Wu, Taipei (TW); Jeffrey F. Jacumin, Connelly Springs, NC (US); Brian J. Severson, Statesville, NC (US)

Correspondence Address: Wen-Chang Wu, 235 Chung - Ho, Box 8-24, Taipei, TW

(21) Appl. No.: 10/192,797

(22) Filed: Jul. 11, 2002

(51) Int. Cl. F21S 8/06

(52) U.S. Cl. 362/404

(57) ABSTRACT

An easily assembled lamp assembling device comprising a supporting frame installed on a light steel frame and a base locking to the supporting frame by screws. Two sides of the supporting frame have respective shrouds. The supporting frame has a buckling hole. The buckling hole extends to the shroud. An open space is formed above the buckling hole. The suspending screw rod is buckled to the opening space. The confining plate is exactly buckled to the buckling hole. Thereby, the suspending screw rod exactly protrudes from the supporting frame. A protruding end of the suspending screw rod exactly passes through a via hole in the base. A lock nut engages the suspending screw rod so that the base is substantially positioned to the supporting frame. A lamp is fixed to a lower side of the though hole. Thereby, an easy assembly lamp is formed.

### BACKGROUND OF THE INVENTION

The present invention relates to lamp assembled devices, and particularly to an easily assembled lamp assembling device.

Referring to FIG. 1, a prior art assembling device of a lamp is illustrated. In assembling a stand lamp, or a seat lamp, or a wall lamp or a ceiling lamp, a light steel frame N is used to lock a top of the lamp. A switch box 3 is locked thereto. A lower end of the switch box 3 is installed with a supporting plate 5 by studs P2. A center of the supporting plate 5 is locked with a stud 6. A lower end of the stud 6 is coupled to a portion of a base 2. A sleeve 22 is used to engage the stud with the base 2. Since in this prior art structure, the stud 6 is directly locked to the lower end of the light steel frame N. The assembly steps must be executed one by one. The base 2 can not assembled in advance. Thereby, the assembly work is complicated and cost in manufacturing process is high.

### SUMMARY OF THE INVENTION

Accordingly, the primary object of the present invention is to provide an easily assembled lamp assembling device comprising a supporting frame installed on a lower end of a light steel frame and a base locking to the supporting frame by screws. Two sides of the supporting frame have respective shrouds. The lower end of the supporting frame has a buckling hole. The buckling hole extends to the shroud. An open space is formed above the buckling hole. The open space has a tapered shape with a larger upper side. A suspending screw rod has a top buckled with a confining plate. The suspending screw rod is buckled to the opening space. The confining plate is exactly buckled to the buckling hole of the supporting frame. Thereby, the suspending screw rod exactly protrudes from a lower end of the supporting frame. A center of the base has a via hole. A protruding end of the suspending screw rod exactly passes through the via hole. A locking nut engages the suspending screw rod so that the base is substantially positioned to the lower end of the supporting frame. A lower end of the base is formed with a though hole. A lamp is fixed to a lower side of the though hole. Thereby, an easy assembly lamp is formed.

The various objects and advantages of the present invention will be more readily understood from the following detailed description when read in conjunction with the appended drawing.

### BRIEF DESCRIPTION OF THE DRAWINGS

FIG. 1 is a cross sectional view of a prior art design.

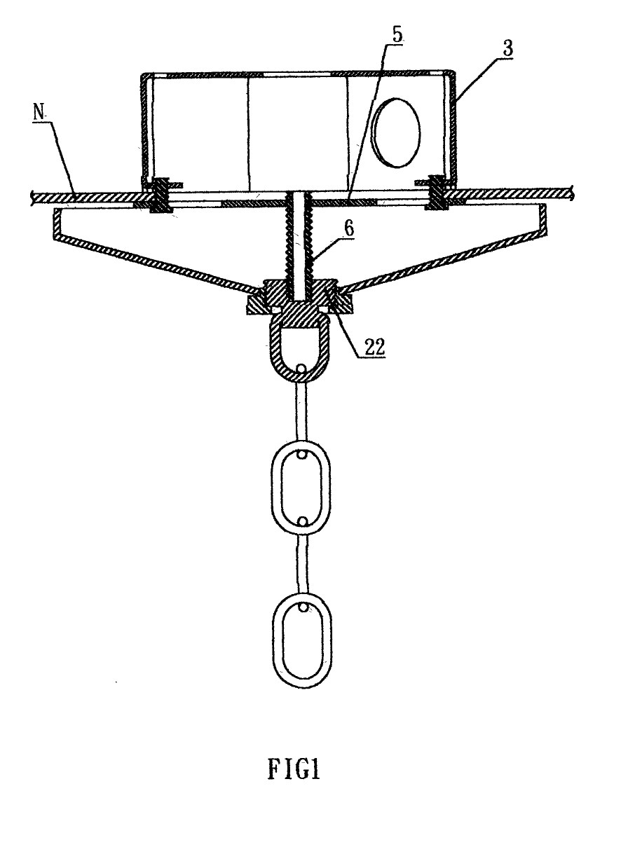

FIG. 2. is an exploded perspective view of the present invention.

FIG. 3 is an assembled perspective view of the present invention.

FIG. 4 is an assembled plane view of the present invention.

FIG. 5 shows another embodiment of the present invention.

FIG. 6 shows a further embodiment of the present invention.

### DETAILED DESCRIPTION OF THE PREFERRED EMBODIMENTS

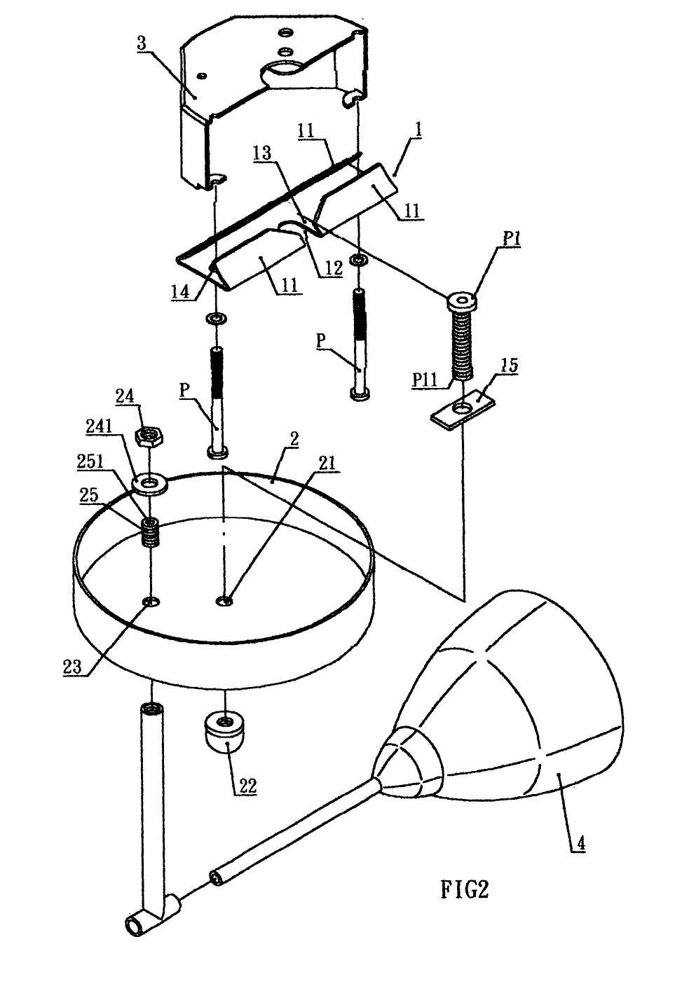

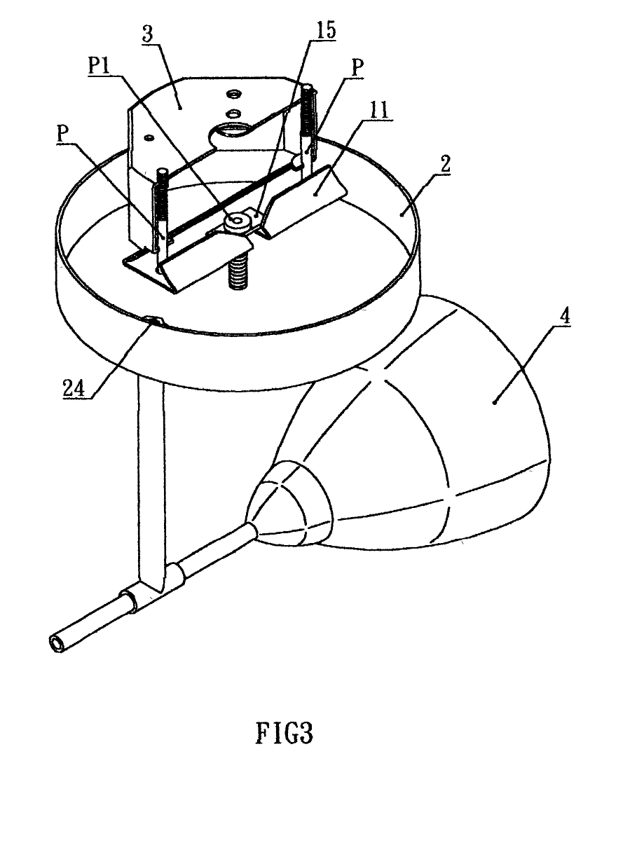

Referring to FIGS. 2 and 3, the structure of the present invention is illustrated. The present invention is mainly formed by a supporting frame 1 installed on a lower end of a light steel frame and a base 2 buckled under the supporting frame 1 by a stud P.

The portion of the light steel frame N locking a ceiling lamp has an opening N1 exactly inserted by a switch box 3 of the ceiling lamp. Thereby, the switch box 3 can be locked to the light steel frame N.

Two sides of the supporting frame 1 have respective shrouds 11 which are bent upwards. A lower end of the supporting frame 1 has a buckling hole 12. One end of the buckling hole 12 extends to the shroud 11. An open space 13 is formed above the buckling hole 12. The open space 13 has a tapered shape with a larger upper side. Two sides of the bottom of the supporting frame 1 are installed with respective locking holes 14. Studs P can pass through the locking holes 14 so that the supporting frame 1 is locked to the lower end of the light steel frame N. A suspending screw rod P1 has a top buckled with a confining plate 15. The suspending screw rod P1 is buckled to the opening space 13 of the supporting frame 1. The confining plate 15 is exactly buckled to an upper side of the buckling hole 12 of the supporting frame 1. Thereby, the suspending screw rod P1 exactly protrudes from a lower end of the supporting frame 1 so as to lock the base 2.

A center of the base 2 has a via hole 21. The protruding end P11 of the suspending screw rod P1 exactly passes through the via hole 21. A lock nut 22 engages the lower end of the suspending screw rod P1 so that the base 2 is substantially positioned to the lower end of the supporting frame 1. A lower end of the base 2 is formed with a though hole 23. An upper side of the though hole 23 is locked with a stud 25 lock to the nut 24 through a washer 241. In that, the lower end of the stud 25 protrudes from the lower end of the base 2 so that the lamp 4 can be locked to this end. A center of the stud 25 has a receiving hole 251 for passing the electric wire so that electric wires S suspending from the light steel frame N can be bent and then extend to the interior of the lamp 4 from the receiving hole 251 of the stud 25.

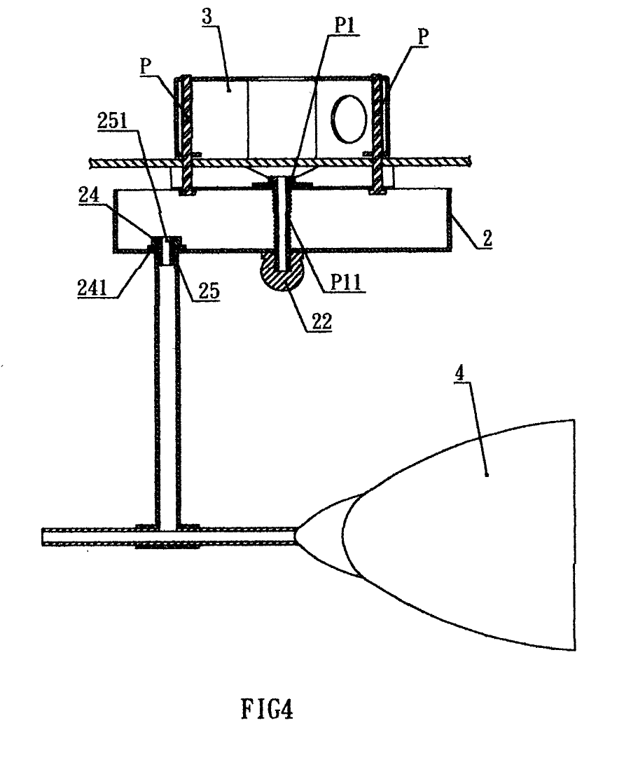

Referring to FIG. 4, by forming a buckling hole 12 at a lower end of the supporting frame 1 and one end of the buckling hole 12 extends to the shroud 11 of the supporting frame 1. An open space 13 is formed on the shroud 11, and the open space 13 has a tapered shape with a large upper opening. A suspending screw rod P1 with a top buckling to a confining plate 15 is embedded into a notch at the top side of the open space 13. Thereby, the nut 22 can lock the base 2 to the suspending screw rod P1. Then suspending screw rod P1 passes through the open space 13 of the supporting frame 1 so that the lamp 4 at the lower end of the base 2 is firmly secured to the lower end of the light steel frame N without needing other locking tools. The assembly work can be executed easily.

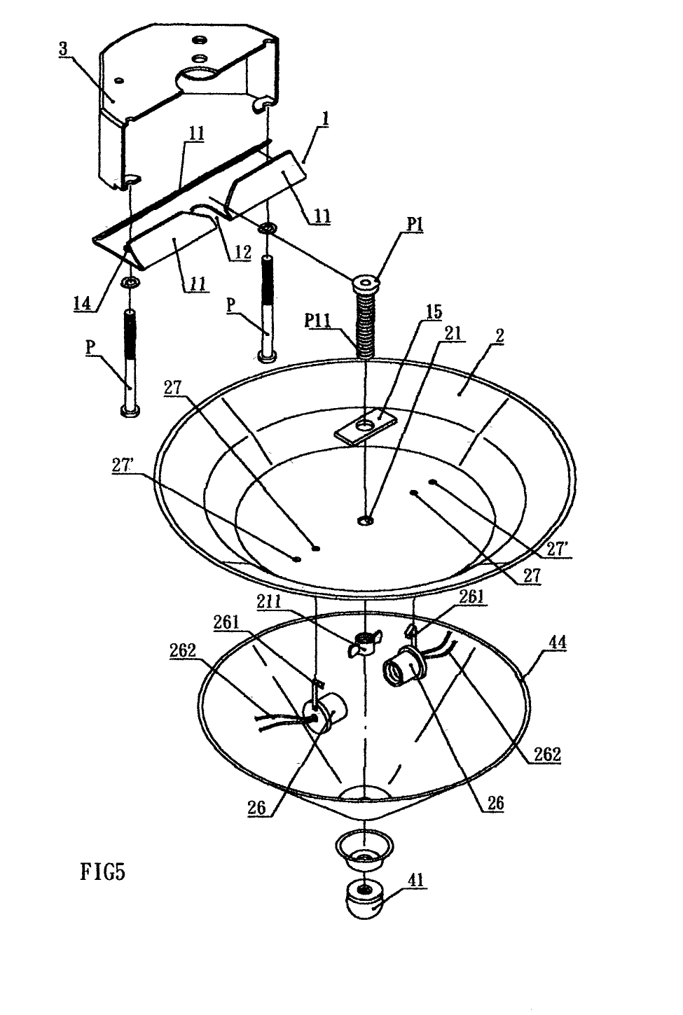

Referring to FIG. 5, another embodiment of the present invention is illustrated. Two sides of the base 2 have pass holes 27, 27′ for buckling the hooks 261 of the lamp seat 26 at the lower side of the base 2. The electric wires 262 of the lamp seat 26 protrude out of the pass holes 27′ to be electrically connected to the switch box 3 on the light steel frame N. A lower end of the via hole 21 of the base 2 is screwedly installed to the lower end of the suspending screw rod P1 so as to position the base 2 to the lower end of the light steel frame N. A nut 41 at the lower side of the base 2 serves to lock a lampshade 4A so as to hide the lamp seat 26 and a disk-like nut 21 in the lampshade 4A.

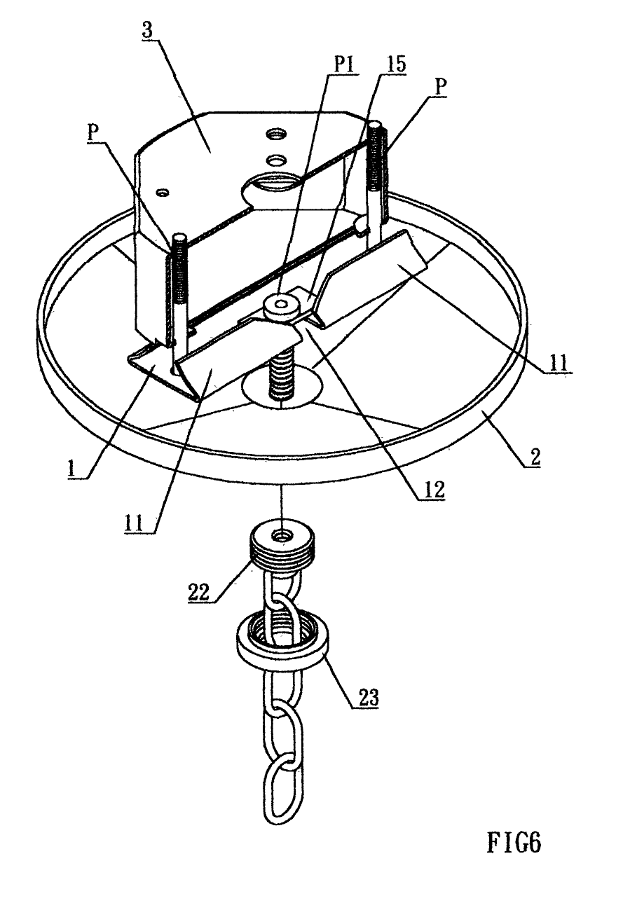

With reference to FIG. 6, a third embodiment of embodiment is illustrated. A center of the base 2 has a via hole 21. A suspending screw rod P1 exactly passes through the via hole 21 with a protruding end P11 exposed from a via hole 21. A circular sleeve 28 is engaged at a lower end of the suspending screw rod P1 to be lock at a portion of the suspending screw rod P1 which is coupled to the base 2. A locking nut 29 locks the lower section of the sleeve. Thereby, the suspending screw rod P1 passes through the notch on the open space 13 of the supporting frame 1 so as to lock the base 2 without using any tool.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An easily assembled lamp assembling device comprising a supporting frame installed on a lower end of a light steel frame and a base locking to the supporting frame by screws; wherein
two sides of the supporting frame have respective shrouds which are bent upwards; a lower end of the supporting frame has a buckling hole; one end of the buckling hole extends to the shroud; an open space is formed above the buckling hole; the open space has a tapered shape with a larger upper side; a suspending screw rod has a top buckled with a confining plate; the suspending screw rod is buckled to the opening space of the supporting frame; the confining plate is exactly buckled to an upper side of the buckling hole of the supporting frame; thereby, the suspending screw rod exactly protrudes from a lower end of the supporting frame so as to lock the base; and
a center of the base has a via hole; a protruding end of the suspending screw rod exactly passes through the via hole; a lock nut engages the lower end of the suspending screw rod so that the base is substantially positioned to a lower end of the supporting frame; a lower end of the base is formed with a though hole; a lamp is fixed to a lower side of the though hole;
thereby, an easy assembly lamp is formed.

2. The easily assembled lamp assembling device as claimed in claim 1, wherein a portion of the light steel frame locking a ceiling lamp has an opening which is exactly inserted by a switch box of a ceiling lamp; thereby, the switch box is locked to the light steel frame.

3. The easily assembled lamp assembling device as claimed in claim 1, wherein two sides of a bottom of the supporting frame are installed with respective locking holes; studs pass through the locking holes so that the supporting frame is locked to the lower end of the light steel frame.

4. The easily assembled lamp assembling device as claimed in claim 1, wherein an upper side of the though hole is locked with a stud which is locked to a nut through a washer and a lower end of the stud protrudes from a lower end of the base so as to lock a lamp; a center of the stud has a receiving hole for passing electric wires so that an electric wire suspending from the light steel frame can be bent and then extend to an interior of the lamp from the receiving hole of the stud.

5. The easily assembled lamp assembling device as claimed in claim 2, wherein each of two sides of the base has two pass holes for buckling hooks of the lamp seat at a lower side of the base; electric wires of the lamp seat protrude out of the pass holes to be electrically connected to the switch box on the light steel frame; a lower end of the via hole of the base is screwedly installed to a lower end of the suspending screw rod so as to position the base to the lower end of the light steel frame; a nut at the lower side of the base serves to lock a lampshade so as to hide the lamp seat and a disk-like nut in the lampshade.

6. The easily assembled lamp assembling device as claimed in claim 1, wherein a circular sleeve is engaged at a lower end of the suspending screw rod to be lock at a portion of the suspending screw rod which is coupled to the base; a locking nut locks the lower section of the sleeve; thereby, the base is positioned to a lower end of the supporting frame.
